(19) United States
(12) Patent Application Publication
(10) Pub. No.: US 2026/0233886 A1
(43) Pub. Date: Aug. 13, 2026

(54) PACKAGING ITEM AND PACKAGED FOOD PRODUCT

(71) Applicant: SOCIÉTÉ DES PRODUITS NESTLÉ S.A., Vevey (CH)

(72) Inventors: Thomas RAEDLER, Lutry (CH); Peter MÜLLER, Yvonand (FR); Abhijit BHATTACHARYA, Epalinges (CH); Jenni Irina JUKARAINEN, Pully (CH); Gerhard NIEDERREITER, Vevey (CH); Nicola GALAFFU, Ornex (FR)

(21) Appl. No.: 19/475,204

(22) PCT Filed: Apr. 23, 2024
(86) PCT No.: PCT/EP2024/061080

§ 371 Date: Oct. 14, 2025

(30) Foreign Application Priority Data
Apr. 24, 2023 (EP) 23169528.9

(51) Int. Cl. B65D 3/26; B32B 1/08; B32B 7/12; B32B 15/12; B32B 27/10; B32B 27/30; B65D 3/04

(52) U.S. Cl. CPC B65D 3/261; B32B 1/08; B32B 7/12; B32B 15/12; B32B 27/10; B32B 27/306; B65D 3/04; B32B 2307/31; B32B 2307/718; B32B 2307/7244; B32B 2307/7265; B32B 2439/70

(57) ABSTRACT

The present invention relates to a packaging item (1) comprising a cylindrical container (2) made of a multilayer oxygen and moisture barrier laminate comprising a cardboard and an organic or inorganic barrier layer. The container has a dispensing opening (8). The packaging item further comprises at least one sliding closure element (11) with at least one sliding closure element peripheral wall (12), the sliding closure element being configured to be slid over at least a top end portion of the container peripheral wall (4) and being made of a multilayer oxygen and moisture barrier laminate comprising a cardboard and an organic or inorganic barrier layer. The present invention further relates to a packaged food item.

### FIELD OF THE INVENTION

The invention relates to a packaging item and a packaged food product.

### BACKGROUND OF THE INVENTION

Packaging items for packaging various types of contents are provided in a variety of different shapes, sizes, and materials. For instance, packaging items made of paper are known from the prior art and are often promoted as being environmentally friendly and more sustainable, e.g., compared with plastic.

However, the existing packaging items made of paper often do not provide the same protection of the contents, e.g., compared with other materials, such as plastic or glass. This may adversely affect one or more properties of the contents, e.g., which may result in a reduced storage life of the contents.

Typically, oxidation and/or moisture intake of the packed contents leads to degradation of the organoleptic properties of said product, which is of course undesirable. In some instances, the food safety can be impaired by transfer of gases and/or moisture through the packaging walls. It is therefore of utmost importance, at least with sensitive food products, to ensure a packaging barrier against gases—in particular oxygen—and moisture.

Moreover, the existing packaging items made of paper often suffer from a reduced structural stability compared with packaging items made from other materials, e.g., plastic or glass. This may adversely affect the handling properties of the packaging items.

Hence, in particular in view of the above-identified drawbacks, it is an object of the present invention to provide a packaging item that provides greater protection to the contents within the packaging item. It is a further object of the present invention to provide a packaging item with improved handling properties.

### Solution to the Problem

In a first aspect, the invention relates to a packaging item as claimed in the appended claims.

More precisely the invention relates to a packaging item comprising:
at least one core container made of a multilayer oxygen and moisture barrier laminate comprising a cardboard and an organic and/or inorganic barrier layer, the cardboard having a grammage comprised between 120 and 600 g/m² and a cellulose content higher than 90%, preferably higher than 95%, more preferably higher than 99%, such that the Oxygen Transmission Rate (OTR) is below 1, preferably below 0.5 cm³/m²/day measured at 23° C. and 50% relative humidity (RH), and the Water Vapour Transmission rate (WVTR) is below 1, preferably below 0.5 g/m²/day measured at 23° C. and 85% RH, said core container including at least one core container peripheral wall and a core container bottom wall, which define at least one compartment for packaging contents, and at least one dispensing opening configured to allow the packaged contents to be dispensed from said core container,
at least one sliding closure element with at least one sliding closure element peripheral wall, and a sliding closure element top wall, the sliding closure element being configured to be slid over at least a top end portion of the core container peripheral wall such that when the packaging item is in its fully closed configuration, the sliding closure element peripheral wall at least partially overlaps and encloses the container peripheral wall and the sliding closure element at least partially covers the dispensing opening of the core container, said sliding closure element being made of a multilayer oxygen and moisture barrier laminate comprising a cardboard and an organic and/or inorganic barrier layer, the cardboard having a grammage comprised between 120 and 600 g/m² and a cellulose content higher than 90%, preferably higher than 95%, more preferably higher than 99%, such that the Oxygen Transmission Rate (OTR) is below 1, preferably below 0.5 cm³/m²/day measured at 23° C. and 50% relative humidity (RH), and the Water Vapour Transmission rate (WVTR) is below 1, preferably below 0.5 g/m²/day measured at 23° C. and 85% RH.

Advantageously, the core container element comprises an edge that is located at the open distal extremity of the peripheral wall, said edge being configured to abut at least partially against the inner surface of the sliding closure element's top wall, when the sliding closure element is slid over the core container element in the fully closed configuration of the packaging item.

In a highly preferred embodiment of the invention, the peripheral wall of the sliding closure element overlaps the peripheral wall of the core container element by at least 25 mm, preferably at least 50 mm, more preferably at least 80 mm, or wherein the peripheral wall of the sliding closure element overlaps at least 30%, preferably at least 50%, more preferably at least 70% of the peripheral wall of the core container element, when the packaging item is in its fully closed configuration.

In another highly preferred embodiment of the invention, the functional play (i.e. the difference between the internal diameter of the sliding closure element and the external diameter of the container element of the package), between the sliding closure element and the core container is comprised between 50 and 500 μm, preferably between 100 and 300 μm.

Such a functional play is sufficient to ensure proper attachment of the two in the closed configuration of the package, and such that no complex capping is necessary such as threads, or clipping mechanism. By selecting a functional play which is comprised preferably between 50 and 500 μm, preferably between 100 and 300 μm, the possibility to easily slide the top sliding closure element onto the core container element is ensured, while the adherence between the two elements is sufficiently high to prevent sliding of one element relative to the other, without applying an external force.

Also importantly, the combination of the functional play and overlap between the sliding closure and container elements ensures tightness of the package in its closed configuration, which allows so-called “open shelf life”. Open shelf life means that when the package is first open, it can be reclosed after first use, with a guarantee that moisture and oxygen intake by the contents is very limited.

Preferably the core container comprises a container top closure configured to close its dispensing opening, wherein the container top closure is at least partially removable from said container.

Advantageously, the core container's top closure is a membrane removable sealed onto the upper edge of the core container, said membrane being made of a material that is barrier to oxygen and moisture, such that the Oxygen Transmission Rate (OTR) is below 1, preferably below 0.5 cm³/m²/day measured at 23° C. and 50% relative humidity (RH), and the Water Vapour Transmission rate (WVTR) is below 1, preferably below 0.5 g/m²/day measured at 23° C. and 85% RH.

Importantly, several cardboard-based packaging material structures can be used for manufacturing the various elements of the present packaging. The various constitutive elements of the packaging can be made out of the same, or different packaging materials. But generally and preferably, the packaging materials that are used are laminates comprising a high cellulosic contents to achieve recyclability in the paper stream processes, and also contain at least one layer that provides barrier properties against oxygen and/or moisture transfer.

Preferably, at least one of the core container, or the sliding closure element, is manufactured from a multilayer cellulosic material comprising:
a paperboard layer having a grammage between 120 g/m² and 600 g/m²,
an optional adhesive layer having a grammage between 0.5 and 10 g/m²,
a paper layer having a grammage comprised between 30 and 120 g/m²,
at least one organic barrier layer of a polymer selected within the list of: polyvinylalcohol (PVOH), ethylene vinyl alcohol (EVOH), butenediol vinyl alcohol co-polymer (BVOH), or a combination thereof, in an amount of 0.5 to 20 g/m², preferably in an amount of 1 to 10 g/m², more preferably in an amount of 2 to 8 g/m²,
at least one inorganic barrier layer selected within the list of: metals, metalloids, or a combination thereof, said inorganic layer having a thickness comprised between 1 and 100 nm, and
at least one organic heat seal layer made of an acrylic or methacrylic acid polymer or polyolefin grafted with at least one type of ionomer, said heat seal layer being applied by aqueous dispersion coating in an amount comprised between 2 and 20 g/m², preferably in an amount comprised between 4 and 9 g/m^{2 .}

Alternatively, at least one of the core container or the sliding closure element is manufactured from a multilayer cellulosic material comprising:

a paperboard layer having a grammage between 120 g/m² and 600 g/m²,
an optional adhesive layer having a grammage between 0.5 and 10 g/m²,
a paper layer having a grammage comprised between 30 and 120 g/m²,
at least one organic barrier layer of a polymer selected within the list of: polyvinylalcohol (PVOH), ethylene vinyl alcohol (EVOH), butenediol vinyl alcohol co-polymer (BVOH), or a combination thereof, in an amount of 0.5 to 20 g/m², preferably in an amount of 1 to 10 g/m², more preferably in an amount of 2 to 8 g/m²,
at least one inorganic barrier layer selected within the list of: metals, metalloids, or a combination thereof, said inorganic layer having a thickness comprised between 1 and 100 nm, and
at least one organic barrier layer of a polymer selected within the list of: polyvinylalcohol (PVOH), ethylene vinyl alcohol (EVOH), butenediol vinyl alcohol co-polymer (BVOH), or a combination thereof, in an amount of 0.5 to 20 g/m², preferably in an amount of 1 to 10 g/m², more preferably in an amount of 2 to 8 g/m²,
at least one organic heat seal layer made of a polyolefin applied by extrusion, said heat seal layer being applied in an amount comprised between 2 and 20 g/m², preferably in an amount comprised between 4 and 9 g/m².

The constitutive elements of the packaging item according to the invention can be selected from any of the two alternative material structures, and they can be either made of the same material or different material chosen from these alternatives.

In one preferred embodiment, the packaged contents:
is an edible product for human and/or animal consumption; and/or,
is configured for producing an edible product for human and/or animal consumption.

Advantageously, the sliding closure element and the core container are configured to be frictionally connected, preferably at least by friction between the container peripheral wall and the sliding closure element peripheral wall, when the sliding closure element is slid over the container.

In a preferred embodiment of the invention, the core container and/or the sliding closure element is/are composed of at least 50 vol % paper, more preferably at least 60 vol % paper, more preferably at least 70 vol % paper, more preferably at least 80 vol % paper, more preferably at least 90 vol % paper, more preferably at least 95 vol % paper.

Advantageously, at least one opening is defined in the sliding closure element peripheral wall, said opening having a diameter comprised between 5 mm and 30 mm, wherein:
the opening is configured to function as a vent that allows gas to pass through the vent into and/or out of the packaging item during and/or prior to opening of the sliding closure element; and/or
wherein the opening is configured as a pouring opening that allows the packaged contents to be dispensed therethrough after sliding the sliding closure element upwards and/or away from the base element.

Preferably, the container is free of printing and/or labels, and optionally wherein the sliding closure element is printed.

The container preferably includes at least one dispensing opening configured to allow the packaged contents to be dispensed from the container through the dispensing opening. The dispensing opening can be of the type that requires full opening of the package (typically by removing at least one element from the rest of the package). Alternatively, or in addition, the packaging can include a second type of dispensing opening that does not require full opening of the packaging, especially one dispensing opening that requires only displacing one element relative to the rest of the package, e.g. by twisting, turning or basculating one portion of the packaging relatively to the rest of the packaging, in order to open/close the packaging.

The multilayer oxygen and moisture barrier laminate comprising the cardboard and the organic and/or inorganic barrier layer increases the resistance of the container, and thus of the packaging item, against oxygen and moisture transfer, e.g., compared with the packaging items made of paper which are known from the prior art. This results in greater protection, preservation and/or a greater storage life of the contents within the container.

The cross section of the packaging item constitutive elements. As understood in the context of the present invention, a “cylinder” preferably has circular cross section (or “base line”). However, also other, e.g., polygonal or elliptical base lines (i.e. cross sections) may be considered as “cylindrical” within the frame of the present invention. Preferably, the cylinder is a right cylinder. However, oblique cylinders can also be considered.

As understood in the context of the present invention a “cardboard” is a cellulosic flat structure of one or more paper layer(s) having a grammage comprised between 120 g/m² and 600 g/m².

Configuring the sliding closure element to be slid over at least a top end portion of the core container peripheral wall such that the sliding closure element peripheral wall at least partially encloses the container peripheral wall and the sliding closure element at least partially covers the dispensing opening, provides greater protection of the contents within the container. In particular, this provides at least a double-walled protection of the packaged contents via the container peripheral wall and the sliding closure element peripheral wall. Moreover, this allows to use the sliding closure element to re-close the dispensing opening of the container after initial opening in a manner that oxygen and moisture barrier properties are maintained.

Alternatively or additionally, such sliding closure element may be utilized for advertising and/or informational and/or aesthetic purposes, e.g., by providing printing at least partially on the sliding closure element, whereas the container may be configured mainly to protect and/or conserve the contents of the packaging item, in particular in a hygienic and/or food safe manner. For instance, the container may be free of printing, adhesives, etc. This minimizes the risk of printing colors or adhesives—for instance—diffusing into the packaged contents (e.g., even if the barrier layer is very thin and/or the packaged contents are stored for extended periods of time). This may also allow the container and the sliding closure element to be manufactured from different materials and/or different material compositions and/or different thicknesses. The sliding closure element peripheral wall may completely enclose the container peripheral wall in a circumferential direction along a certain portion of the container's length.

Configuring the cardboard to have a relatively high cellulose content, e.g., higher than 90%, preferably higher than 95%, more preferably higher than 99%, reduces the density and/or the production costs and/or increases the biodegradability and/or the recyclability of the packaging item, e.g., compared with materials which have a lower cellulose content.

The packaging item, more specifically the container, is configured to house and/or preserve, at least for a certain time period, food material in the compartment, i.e., any material used as food, e.g., edible/drinkable material, or used to make/produce food. The packaged material, e.g., food material, may be liquid and/or solid matter. Preferably, the packaged material is solid, and in flowable format, in particular in powder format. The powder can have various granularity values, from small to coarse diameter particles, or be a mix of large and small diameter powder particles. It can also take the form of kibbles, or solid particle items of various shapes and sizes, which are either individually prepacked food items or not. The type of food product can be of wide range like e.g. coffee particles or solids, potato chips, chocolate solids, petfood kibbles, compacted edible items such as e.g. compacted coffee doses, etc.

The above-identified components of the packaging item, e.g., the core container and the sliding closure element, may be provided in a range of different dimensions. Preferably, the container may have a width/diameter in a range of 20 mm to 200 mm. Preferably, the container may have a length in a range of 50 mm to 500 mm, preferably 75 mm to 250 mm.

Preferably the diameter of the elements are such that they allow a comfortable handling with a user hand. The diameter is advantageously comprised between 20 and 200 mm, preferably between 40 and 100 mm.

The dispensing opening may be arranged at an end of the container, e.g., at the top end of the container. Alternatively, or additionally, the dispensing opening may be defined at least partially in the container peripheral wall.

The container bottom closure is a membrane and/or a foil, e.g., a metal, e.g., aluminium, or a metalized material, e.g., a metalized paper or a metalized plastic, such as a metallized polyolefin, preferably a metalized polypropylene. Alternatively, or additionally, the container bottom closure may be made of plastic, e.g., a polymer such as polyethylene terephthalate (PET).

The content percentage(s) of the material(s) mentioned above, e.g., the cellulose content, are defined in wt% relative to a total weight of the respective material.

Preferably the sliding closure element and the core element are “cylindrical”. More preferably, the sliding closure element and the core element are shaped as a cylinder having a circular base line (i.e. “cross section”). The inner and/or outer diameter of the cylinder forming the sliding closure element and the cylinder forming the core element may be the same. By “cylindrical”, it is meant—within the frame of the present specification—that the container, the sliding closure element and the core element may be formed as a cylinder having also an elliptical or polygonal cross section.

Preferably, the sliding closure element and the core container are configured such that the sliding closure element can be removed from, and slid over the container multiple times. This may allow the container to be opened and reclosed multiple times by the sliding closure element.

Preferably, the packaging item further includes at least one container top closure configured to close, preferably sealingly close, the dispensing opening of the upper edge of the core container, in order to prevent the packaged contents from being dispensed through the dispensing opening. Preferably, the container top closure is at least partially removable, preferably peelable, from the dispensing opening. The container top closure may be a membrane and/or a foil, e.g., a metal, e.g., aluminium, or a metalized material, e.g., a metalized paper or a metalized plastic, such as a metalized polyolefin, preferably a metalized polypropylene. Alternatively, or additionally, the container top closure may be made of plastic, e.g., a polymer such as polyethylene terephthalate (PET).

In other words, the container top closure may provide a moisture and oxygen barrier that is removable upon initial opening of the packaging item by the consumer (e.g., after removing the sliding closure element). Subsequently, the container opening may be re-closed by sliding (or re-sliding) the sliding closure element onto the container.

Generally, the constitutive elements of a package according to the present invention are chosen within packaging materials comprising a high contents of cellulose, and having barrier properties against oxygen and moisture. Such barrier properties are achieved by incorporating organic and/or inorganic layers in the packaging material structure, such as to provide values of Oxygen Transmission Rate (OTR) below 1, preferably below 0.5 cm³/m²/day measured at 23° C. and 50% relative humidity (RH), and values of water vapour transmission rate (WVTR) below 1, preferably below 0.5 g/m²/day measured at 23° C. and 85% RH.

Preferably, the packaged contents is a bulk solid, preferably a flowable bulk solid, preferably a flowable powder. The powder may include granules and/or particles. Preferably, the packaged contents is a coffee powder, preferably a soluble and/or freeze-dried coffee powder, or a milk powder.

Preferably, the packaged contents is an edible product for human and/or animal consumption and/or the packaged contents is configured for producing an edible product for human and/or animal consumption.

Preferably, the top sliding closure element and the core container are configured to be frictionally connected, preferably at least by friction between the container peripheral wall and the sliding closure element peripheral wall, when the sliding closure element is slid over the core container. This may provide a relatively sturdy connection and/or seal between the sliding closure element and the container. This may increase the storage life of the contents in the packaging item. Moreover, this may prevent the sliding closure element from inadvertently dislodging from the container, e.g., when the user grips only the sliding closure element and lifts the packaging by the sliding closure element.

Preferably, when the sliding closure element is slid onto the container, the sliding closure element peripheral wall overlaps the container peripheral wall in an axial direction along at least 50%, preferably at least 60%, more preferably at least 70%, of an axial length of the container. It is believed that these lengths may provide for an adequate frictional connection between the sliding closure element and the container as well as adequate moisture and oxygen barrier properties for keeping the packaged contents fresh.

Preferably, at least one opening is defined in the top sliding closure element, preferably in the sliding closure element peripheral wall, more preferably adjacent to a top end of the sliding closure element peripheral wall. The opening may be configured to function as a vent that allows gas to pass through the vent into and/or out of the packaging item during opening of the sliding closure element. This may at least partially equalize a pressure within the packaging item vis-á-vis an environment which may facilitate removal of the sliding closure element. Alternatively, or additionally, the opening may be configured as a pouring opening that allows the packaged contents to be dispensed therethrough after sliding the sliding closure element upwards and/or away from the base element.

In the context of the present invention, any of the barrier layers may be provided as an organic barrier layer, e.g. a barrier layer made a polyethylene vinyl alcohol-type polymer, or a compound thereof (PVOH, EVOH, BVOH, or compounds thereof). The thickness of the organic layer, e.g. the thickness of a PVOH layer, may be less than 20 μm, preferably less than 10 μm, or more preferably less than 8 μm. Any organic layers in the structure, if present, are preferably deposited by an aqueous dispersion process, which provides low thickness, easy separation of molecules in a recycling process, and therefore a high compatibility with paper recycling stream processes. Any inorganic barrier layer, if present in the packaging material structure, may comprise a metal such as aluminum, and/or a metalloid such as SiOx (silicon oxide) or AlOx (aluminium oxide). The barrier layer may also be made from a combination of various layers, e.g. at least one organic layer (e.g. PVOH) and at least one inorganic layer (e.g., aluminum).

In a second aspect, the invention also relates to a packaged food product which includes at least one packaging item according to any of the embodiments described herein and at least one food material contained within the container of the packaging item.

Preferably, the food material is a bulk solid, preferably a flowable bulk solid, preferably a flowable powder. The powder may include granules and/or particles. Preferably, the packaged contents is a coffee or milk powder, preferably a soluble coffee powder.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 schematically shows a schematic cut view of a packaging item according to an embodiment of the invention in an assembled state;

FIG. 2 schematically shows a schematic cut view of the top sliding element for a packaging item according to the invention;

FIG. 3 schematically shows a schematic cut view of the core container element for a packaging item according to the invention;

FIGS. 4A and 4B are schematic views showing the partial lifting of one packaging element relative to the others, in order to open a dosing opening.

### DETAILED DESCRIPTION

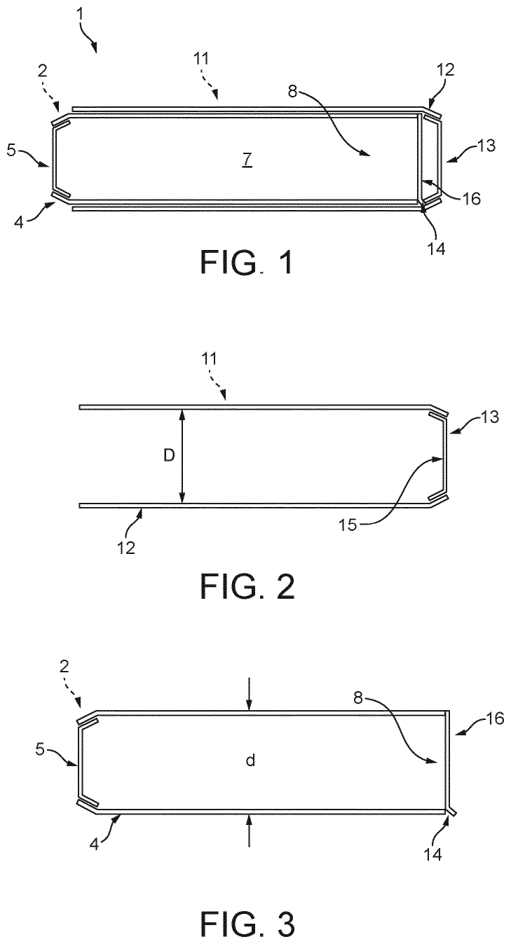

FIGS. 1, 2 and 3 show a packaging item 1 which comprises a cylindrical core container 2 made of a multilayer oxygen and moisture barrier laminate.
The multilayer oxygen and moisture barrier laminate comprises a cardboard, an organic barrier layer for oxygen barrier-which comprises a PVOH and/or an EVOH, and an inorganic barrier layer for moisture barrier, as well as an internal heat seal layer. All organic layers are deposited by aqueous dispersion coating, in this exemplary embodiment. The inorganic layer is vacuum deposited aluminium. The cardboard has a grammage comprised between 120 and 600 g/m² and has a cellulose content higher than 90%, preferably higher than 95%, more preferably higher than 99%.

The core container 2 which is illustrated in more detail in FIG. 3 includes a core container peripheral wall 4 and a container bottom closure (or “container bottom wall”) 5 which define at least one compartment 7 for packaging contents, e.g., a food material. The core container 2 further comprises a dispensing opening 8 configured to allow the packaged contents to be dispensed from the core container 2 through the dispensing opening 8.

The packaging item 1 further comprises a sliding closure element 11 with a sliding closure element peripheral wall 12. The sliding closure element 11 is represented alone in FIG. 2 and further comprises a sliding closure element top wall 13 which closes at least partially the top extremity of said sliding closure element 11. The sliding closure element 11 is configured to be slid over the core container peripheral wall 4, as depicted in FIG. 1, such that the sliding closure element peripheral wall 12 at least partially encloses the core container peripheral wall 4, and the sliding closure element 11 at least partially covers the dispensing opening 8. The sliding closure element 11 may be made of a multilayer oxygen and moisture barrier laminate comprising a cardboard and an organic barrier layer. The cardboard may have a grammage comprised between 120 and 600 g/m² and/or a cellulose content higher than 90%, preferably higher than 95%, more preferably higher than 99%.

The packaging item 1 can further comprise additional constructional elements, beyond the two constitutive parts described above. The construction can include as many elements as necessary, although two elements are definitely sufficient to provide a proper oxygen and moisture barrier to protect the contents.

The packaging item 1 further includes a container top closure 16 configured to close, preferably sealingly close, the dispensing opening 8 of the core element 2 to prevent the packaged contents from being dispensed through the dispensing opening 8. The container top closure 16 may be sealed (e.g., by a heat seal, adhesive, and/or welding) to the top end (i.e. upper edge) portion 14 of the container peripheral wall, in particular around the dispensing opening 8. The container top closure 16 is at least partially removable from the dispensing opening 8, e.g. upon initial opening of the core container 2. Once the container top closure 16 has been at least partially removed from the dispensing opening 8, the core container 2, more specifically the dispensing opening 8, may be reclosed and reopened, preferably multiple times, by sliding the sliding closure element 11 over the core container 2 and removing it therefrom.

The packaging item 1 further includes a second opening 17 defined in the sliding closure element peripheral wall 12. The second opening 17 may be configured to be at least partially closeable, preferably re-closeable, preferably multiple times. The second opening 17 is closed by the container peripheral wall when the sliding closure element 11 is slid, e.g. fully slid, onto the core container 2, and/or the second opening 17 may be opened and re-closed by rotation of the sliding closure element 11 with respect to the core container 2 (e.g., by providing a cut out along a portion of the core container peripheral wall 4 that is configured to overlap with the second opening 17 in the sliding closure element peripheral wall 12 when the second opening 17 is open).

The second opening 17 may be configured to function as a vent that allows gas to pass therethrough into and/or out of the packaging item 1 during and/or prior to opening of the sliding closure element 11. Alternatively, or additionally, the second opening 140 may function as a pouring opening that allows the contents to be dispensed therethrough, preferably after sliding the sliding closure element 11 upwards and/or away from the core container 2.

As illustrated in FIG. 1, when the packaging item is in its fully closed configuration, an abutment between the inner surface of the sliding element top wall, and the upper edge of the core element peripheral wall, ensures that the mechanical resistance of the packaging item against a top load (i.e. in the vertical direction) is guaranteed, because the forces exerted in the vertical direction are held by this contact point at the interface between the upper edge of the cylindrical core container element, and the internal surface of the sliding closure element upper wall.

Stackability of the whole packaging item, is thus guaranteed, which ensures that the integrity of each individual package is not impacted when a lot of such packages are piled up one onto the other for transportation or storage.

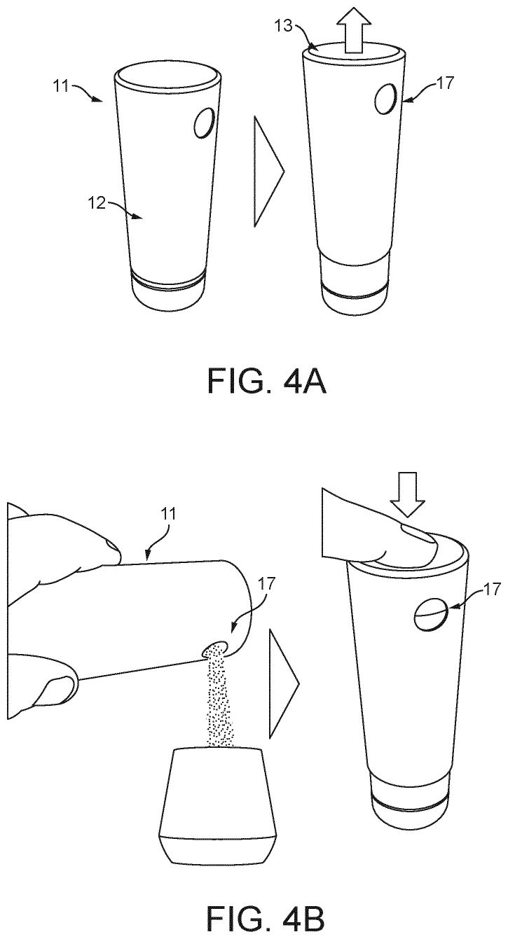

As depicted in FIGS. 4A and 4B, the packaging may comprise a dosing opening 170 in the side of the sliding closure element 11. By lifting the sliding closure element 11 (without detaching it from the rest of the packaging), a passage is created between the interior compartment of the packaging, and the dosing opening 170, so as to create a passage for the product. The diameter (comprised between 5 mm and 30 mm) of the dosing opening is sufficient to let some product flow out in a metered quantity and flow, which allows to conveniently dose the product as illustrated in FIG. 4B. After dosing, the sliding closure element 11 is pushed back onto the rest of the packaging to close the latter.

Various aspects and embodiments of the invention have been described for purposes of illustration. The invention, however, should not be unduly limited by any of the details of the above disclosure, as a person skilled in the art will appreciate that changes and modifications that do not contradict the principle of the invention may be made and are still covered by the invention. In particular, the invention shall not be construed to be limited to the embodiments described above with reference to the drawings. Rather, the scope of protection of the invention is determined solely by the appended claims and their equivalents.

Generally, the packaging according to the present invention provides a certain number of advantages and benefits to a user, as follows.

It provides a unique structural design, using a cardboard packaging with unique tube shape, size; the construction is made of cardboard which is recyclable in a paper stream process.

It comprises an innovative closure system: a tube packaging with a novel “lift & push” mechanism for closure that enables user friendly opening, closing and reseal (easy to seal and reseal, while also being secure and protective). In particular, the only attachment for the upper sliding closure element onto the core container is done by sliding one over the other. The functional play between the two is sufficient to ensure proper attachment, and such that no complex capping is necessary such as threads, or clipping mechanism. By selecting a functional play which is comprised preferably between 50 and 500 μm, preferably between 100 and 300 μm, the possibility to easily slide the top sliding closure element onto the core container element is ensured, while the adherence between the two elements is sufficiently high to prevent sliding of one element relative to the other, without applying an external force. By “functional play” it is meant the difference between the internal diameter “D” of the sliding closure element 11 and the external diameter “d” of the core container element 2 as illustrated in FIGS. 2 and 3.

The innovative packaging according to the present invention provides so-called “open shelf life” capabilities, which means that after the package is first open for use, its closed configuration allows to preserve a high level of barrier, which prolongs the shelf life of the contents. This open shelf life is made possible by the fact that moisture and oxygen transfer are minimal when the top sliding closure element fully closes the container element. In such closed position, the package still has values of Oxygen Transmission Rate (OTR) below 1, preferably below 0.5 cm³/m²/day measured at 23° C. and 50% relative humidity (RH), and values of water vapour transmission rate (WVTR) below 1, preferably below 0.5 g/m²/day measured at 23° C. and 85% RH. This is due to the fact that the functional play (i.e. the space) between the internal surface of the sliding closure element and the external surface of the container element is sufficiently small, and simultaneously, the overlap between the sliding closure and container elements is sufficiently high, to ensure that-while allowing movement between the two by application of a sliding force-the transfer of moisture and gases is largely prevented.

The package according to the invention can advantageously comprise holes/perforations in the cardboard structure that enables precise and user-friendly dosing of its contents, as a “doser” or “dosage dispenser”, a mechanism that allows the user to dispense a specific amount of product from the packaging, typically for precise and convenient usage.

It is manufactured out of sustainable material: a tube cardboard packaging made from eco-friendly/biodegradable/recyclable and/or compostable materials, that have built-in barrier capabilities in order to ensure long shelf-life and product freshness without noticeable impact on organoleptic properties.

It comprises customizable features, especially a tube cardboard packaging that can be customized to fit different product types and customer needs, such as size, shape, or color.

It comprises special high barrier functionality against transfer of gases and moisture through its walls. The packaging material that was developed provides high barrier functional properties that enhances the food protection and usability, such as oxygen transmission rate (OTR), moisture resistance (WVTR), odor-blocking properties.

Optionally, but preferably, the packaging material is UV-resistant or light-blocking, hence of particular interest for packing certain food categories which are UV sensitive.

While being resistant to stacking forces and top load mechanical stress (to which packages are subject when transported and stored in piles), the tube packaging uses a cardboard material that is sufficiently flexible so that it can be folded or collapsed, and therefore takes less space after use when it is discarded.

The packaging according to the present invention is a shock-absorbing/cushioning system: the mechanical resilience of the current tube material and the headspace that is integrated into the packaging cavity creates an air pocket feature, so that it protects sensitive products during shipping or handling, against mechanical shocks.

The simple shape of this packaging creates a stackable design that minimizes product movement/optimizes shipping.

The fact that cardboard material is used with a very high contents in cellulose creates a sound dampening effect and reduces noise during transport and while opening closing and reseal. This packaging is very user-friendly to use in that regard.

The preferred shape and diameter of the tubes are chosen such that they adapt to a human hand for high ergonomic and easy-grip design.

1. A packaging item comprising:
at least one core container comprising a multilayer oxygen and moisture barrier laminate, the multilayer oxygen and moisture barrier comprising a cardboard and further comprising an organic and/or inorganic barrier layer, the cardboard having a grammage comprised between 120 and 600 g/m² and a cellulose content higher than 90%, such that an Oxygen Transmission Rate (OTR) is below 1 cm³/m²/day measured at 23° C. and 50% relative humidity (RH), and a Water Vapour Transmission rate (WVTR) is below 1 g/m²/day measured at 23° C. and 85% RH, the at least one core container including at least one core container peripheral wall and a core container bottom wall, which define at least one compartment for packaging contents, and the at least one core container further comprising at least one dispensing opening configured to allow the packaging contents to be dispensed from the at least one core container,
at least one sliding closure element with at least one sliding closure element peripheral wall, and the at least one sliding closure element further comprising a sliding closure element top wall, the at least one sliding closure element configured to be slid over at least a top end portion of the at least one core container peripheral wall such that when the packaging item is in a its fully closed configuration, the at least one sliding closure element peripheral wall at least partially overlaps and encloses the at least one container peripheral wall and the at least one sliding closure element at least partially covers the at least one dispensing opening of the at least one core container, said the at least one sliding closure element comprising a multilayer oxygen and moisture barrier laminate, the multilayer oxygen and moisture barrier laminate comprising a cardboard and further comprising an organic and/or inorganic barrier layer, the cardboard having a grammage between 120 and 600 g/m² and a cellulose content higher than 90%, such that an Oxygen Transmission Rate (OTR) is below 1 cm³/m²/day measured at 23° C. and 50% relative humidity (RH), and a Water Vapour Transmission rate (WVTR) is below 1 g/m²/day measured at 23° C. and 85% RH.

2. The packaging item according to claim 2, wherein the at least one core container element comprises an edge that is located at an open distal extremity of the at least one core container peripheral wall, the edge configured to abut at least partially against an inner surface of the sliding closure element top wall, when the at least one sliding closure element is slid over the at least one core container element in the fully closed configuration of the packaging item.

3. The packaging item according to claim 2, wherein functional play between the at least one sliding closure element and the at least one core container is between 50 and 500 μm.

4. The packaging item according to claim 1, wherein the at least one sliding closure element peripheral wall overlaps the at least one core container peripheral wall by at least 25 mm, or wherein the at least one sliding closure element peripheral wall overlaps at least 30%, of the at least one core container peripheral wall, when the packaging item is in the fully closed configuration.

5. The packaging item according to claim 1, wherein the at least one core container comprises a container top closure configured to close a dispensing opening of the at least one core container, wherein the container top closure is at least partially removable from the at least one core container.

6. The packaging item according to claim 5, wherein the container top closure is a membrane removably sealed onto an upper edge of the at least one core container, the membrane comprising of a material that is a barrier to oxygen and moisture, such that an Oxygen Transmission Rate (OTR) is below 1 cm³/m²/day measured at 23° C. and 50% relative humidity (RH), and a Water Vapour Transmission rate (WVTR) is below 1
g/m²/day measured at 23° C. and 85% RH.

7. The packaging item according to claim 1, wherein at least one of the at least one core container or the at least one sliding closure element comprises a multilayer cellulosic material comprising:
a paperboard layer having a grammage between 120 g/m² and 600 g/m²,
an optional adhesive layer having a grammage between 0.5 and 10 g/m²,
a paper layer having a grammage between 30 and 120 g/m²,
at least one organic barrier layer of a polymer selected from the group consisting of: polyvinylalcohol (PVOH), ethylene vinyl alcohol (EVOH), butenediol vinyl alcohol co-polymer (BVOH), and a combination thereof, in an amount of 0.5 to 20 g/m²,
at least one inorganic barrier layer selected from the group consisting of: metals, metalloids, and a combination thereof, the at least one inorganic barrier layer having a thickness between 1 and 100 nm, and
at least one organic heat seal layer comprising an acrylic or methacrylic acid polymer or polyolefin grafted with at least one type of ionomer, the at least one organic heat seal layer applied by aqueous dispersion coating in an amount between 2 and 20 g/m².

8. The packaging item according to claim 1m wherein at least one of the at least one core container or the at least one sliding closure element comprises a multilayer cellulosic material comprising:
a paperboard layer having a grammage between 120 g/m² and 600 g/m²,
an optional adhesive layer having a grammage between 0.5 and 10 g/m²,
a paper layer having a grammage between 30 and 120 g/m²,
at least one organic barrier layer of a polymer selected from the group consisting of: polyvinylalcohol (PVOH), ethylene vinyl alcohol (EVOH), butenediol vinyl alcohol co-polymer (BVOH), and a combination thereof, in an amount of 0.5 to 20 g/m²,
at least one inorganic barrier layer selected from the group consisting of: metals, metalloids, and a combination thereof, the at least one inorganic barrier layer having a thickness between 1 and 100 nm, and
at least one organic barrier layer of a polymer selected within the list of:
polyvinylalcohol (PVOH), ethylene vinyl alcohol (EVOH), butenediol vinyl alcohol co-polymer (BVOH), or a combination thereof, in an amount of 0.5 to 20 g/m², preferably in an amount of 1 to 10 g/m²,
at least one organic heat seal layer comprising a polyolefin applied by extrusion, the at least one organic heat seal layer applied in an amount between 2 and 20 g/m²,

9. The packaging item according to claim 1, wherein the packaging contents:
is an edible product for human and/or animal consumption;
and/or
is configured for producing an edible product for human and/or animal consumption.

10. The packaging item according to claim 1, wherein the at least one sliding closure element and the at least one core container are configured to be frictionally connected, when the at least one sliding closure element is slid over the at least one core container.

11. The packaging item according to claim 1, wherein the at least one core container and/or the at least one sliding closure element is/are composed of at least 50 vol % paper.

12. The packaging item according to claim 1, wherein at least one opening is defined in the at least one sliding closure element peripheral wall, the at least one opening having a diameter between 5 mm and 30 mm, wherein:
the at least one opening is configured to function as a vent that allows gas to pass through the vent into and/or out of the packaging item during and/or prior to opening of the at least one sliding closure element; and/or
wherein the opening is configured as a pouring opening that allows the packaging contents to be dispensed therethrough after sliding the at least one sliding closure element upwards and/or away from a base element.

13. The packaging item according to claim 1, wherein the at least one core container is free of printing and/or labels.

14. A packaged food product, including:
the packaging item according to claim 1; and
at least one food material contained within the at least one core container of the packaging item.

15. The packaged food product according to claim 14, wherein the food material is a bulk solid.

16. The packaging item according to claim 2, wherein functional play between the at least one sliding closure element and the at least one core container is between 100 and 300 μm.

17. The packaging item according to claim 1, wherein the at least one sliding closure element peripheral wall overlaps the at least one core container peripheral wall by at least 80 mm, or wherein the at least one sliding closure element peripheral wall overlaps at least 70% of the at least one core container peripheral wall, when the packaging item is in the fully closed configuration.

18. The packaging item according to claim 1, wherein the at least one core container and/or the at least one sliding closure element is/are composed of at least 95 vol % paper.
